(19) United States
(12) Patent Application Publication
(10) Pub. No.: US 2007/0250466 A1
(43) Pub. Date: Oct. 25, 2007

(54) METHOD AND SYSTEM FOR GENERATING AN ANALYTICAL REPORT INCLUDING A CONTEXTUAL KNOWLEDGE PANEL

(76) Inventors: Shriharsha Imrapur, Dharwad (IN); Vinod Sarma, Bangalore (IN); Derick Jose, Bangalore (IN)

Correspondence Address: Global IP Services, PLLC, 198 F, 27th Cross. 3rd Block Jayanagar, Bangalore, 560011, IN

(21) Appl. No.: 11/379,224

(22) Filed: Apr. 19, 2006

(51) Int. Cl. G06F 17/30

(52) U.S. Cl. 707/1

(57) ABSTRACT

Described is a method and system for producing and displaying a required analytical report based on user-determined rule-set, selectively including contextual information that is specifically linked to the analytical report. Certain report-attributes, e.g., role ID, subscriber ID, and report ID/what-if ID, which are characteristic of the required report, are inputted into a user's system/framework to obtain outputs specific to the required analytical report by narrowing down/filtering the selection from available contextual information to obtain specific contextual information used for selective display. The method includes specific steps to use filter/narrow-down choices, considering what-if and different possible scenarios. The method can be part of commercial software that is tailored to the user's requirements and sold as a package. The analytical report might include contextual metadata, associated analytics for a particular analysis scenario, event alerts and operational metadata as part of a contextual knowledge panel. The display may have an L shaped configuration.

### FIELD OF THE INVENTION

This invention relates generally to a method and system for providing software services, and more particularly to a method and system for integrating and customizing software components with the help of a user interface such as a browser.

### BACKGROUND OF THE INVENTION

Reports which are displayed incorporating information and data are very useful tools in presentation and analyzing data. Prior art provides examples of generating reports and presenting information from different sources. U.S. Pat. No. 6,944,612 B2 to Roustant et al, teaches a search engine that categorizes and groups search results based on search result attributes. U.S. Pat. No. 6,944,679 B2 to Parupudi et al, teaches a system that provides context specific/location specific information applicable to vehicles. U.S. Pat. No. 6,973,460 B1 to Mitra, teaches a framework which gathers information from metadata within an object model. U.S. Pat. No. 6,976,020 B2 to Anthony et al, teaches an environment in software that permits separation of control functions and their contexts, and includes a system for translating documents from one model to another. U.S. Pat. No. 6,980,816 B2 to Rohles et al, teaches a method in a wireless communication service, of requesting contextual information from a source outside a communication device. U.S. Pat. No. 6,980,993 B2 to Horvitz et al, teaches a schema based platform where information service schemas and services are combined to build a content-sensitive and context sensitive information service to users. U.S. Pat. No. 6,988,132 B2 to Horvitz teaches a system for establishing preferred modalities/channels for communication, based on user's preferences and capabilities. U.S. Pat. No. 6,990,532 B2 teaches a method that provides partner-sensitive and context sensitive information.

Numerous software products providing a variety of functionalities are available for users to purchase and use. Despite the abundance of software products available, many users must customize their software installations in order to meet their particular requirements. Other users are unable to find a complete solution to their particular requirements in any single software product and try to integrate several existing software packages to achieve the desired functionality. Even if a user is able to integrate several software packages together, the cost may be greater than the customer's budget permits. Also, all of the software functionalities in each of the software products may not be used, further exacerbating the cost issue.

Reports incorporating information and data are used extensively in forecasting, data analysis and tracking information-changes. However, when one views any reports, there may be a lot of surrounding context which is missing in the layout of the report, and the missing context would serve to lend a lot of knowledge about the analysis scenario. The missing context could be related to (but not limited to) a few sample questions that are varied in nature from simple aspects like:
Where did the data come from?
Who owns the data?
How fresh is the data?
What is the perspective of other people who have looked at the report?

to more complex aspects like:
If the present report has been analyzed, what are the relevant reports which are valid with respect to the current report?
When was the last time the data in the current report got refreshed?
When is the next time the data in the current report would get refreshed?

There is a need for addressing the above requirements and provide a method and system that would cater to providing the report-users specific information relating to certain missing context in the reports.

### SUMMARY OF THE INVENTION

The invention teaches a method and system that enable a user to produce and display an analytical report, selectively including contextual information that is specifically linked to the analytical report. The contextual metadata may be dynamic with every invoked analytical report. Also, in one application, the items in the analytical report may be associated with subscribers, action items, events and comments. The report may be based on specific contextual data relating to and associated with items like the source of data, who owns the data, freshness of the data, other people's views of the report, other relevant reports, as well as valid business events connected with the present report. The relationship between an analytical report and the analytical approach to arrive at the report is flexible and is user defined.

The contextual metadata framework in one application encompasses operational metadata, events metadata, action items to be triggered under the current context, related analysis-scenarios metadata and comments metadata. The contextual metadata, from another angle might include: a) analytics for a particular analysis, b) a panel listing of operational data including data source, % of rejects, and data owners, c) a panel listing of “what-if” scenarios, and, d) related analytical areas of interest to the current user, based on current analysis, and e) a panel consisting of action items which can be triggered from the current reporting context.

One implementation of the invention is termed an “L” shaped report display and basically addresses the questions addressed supra, by bringing/consolidating contextual information, and generating specific contextual information that is linked to a required report. For this purpose, certain report-attributes which are characteristic of the required report are inputted into a user's system/framework to obtain specific outputs. The heart of this whole framework is the underlying metamodel which captures all relationships. Expediently, in one form of the invention, every instance of the report is associated with subscribers, action options, events, and comments.

In one embodiment, the invention resides in a method of producing and displaying a required analytical report for displaying data including and based on specific contextual information which is specific to the required analytical report by filtering available general contextual information, comprising the steps of: selecting report-attributes which are characteristic of the required analytical report; inputting said report attributes individually into a user interface and gaining access into the available general contextual information; selecting a rule-set determined by the user for deriving events/specific information to be watched/displayed; using the inputted report attributes and said rule-set for narrowing down and filtering selections from available general contextual information to arrive at said specific contextual information relevant to the required analytical report; and, selectively displaying the data and the specific contextual information to the user as prompted. The role ID might have relevance to the person who is using the report, where the person, for example might be a company CFO, or a business analyst, or a sales consultant or an investor who is keeping track of the profit levels or the stock values in a company. The specific contextual information might include events, alerts, inflexion points in certain graphs, and other variables which the user might like to watch and keep track of.

For instance, the user might like to track the sales figures, or stock price variations of a particular stock, or financial variations in the financial situation of a company, etc. For example, the end information consumer who is tracking sales figures may notice through the events metadata panel that the sales numbers missed the targets 3 times in the last 7 months. He may notice that the contribution of certain products to the overall sales is declining (inflecting downwards).

If the end-information consumer notices that there is a spike which happens in sales for a given time-frame based on past data, he may then be guided to the related reports-panel and view the stock-out situations for that region based on the warehouse holdings.

If on the other hand, the end-information consumer notices that there is a discrepancy in the sales numbers, he may view the source metadata panel for further information. This panel could attribute the discrepancy to one or more of the following:
the information is not coming from a trusted source (visible from source system tag)
while loading the data repository, a majority of the sales data got rejected due to business rule violations (visible from the percentage rejects tag)

If the end-information consumer notices that there is a dip in the sales numbers, he may look into the comments panel which would give him a perspective of how other information-consumers of this report, attributed the discrepancy in sales numbers to a cause. The discrepancy could be due to a competitive promotional event, or it could be due to an attribute not valued by the customers. In any case a subjective comment is entered into the comments panel, which is visible for multiple information consumers.
If however, the person consuming sales information notices a dip in the sales figures continuously for last 3 months he may decide to trigger one of the following actions:
A) Introduce a temporary price reduction for the item which is slow-moving.
B) Introduce a gift scheme along with the item which is slow-moving.
C) Call for a meeting of regional sales people to discuss the trend.

Stand Alone Mode Claims

The concept of relating a role and report to an associated “what if’, scenario which can be activated within the context of this report is as follows:
The concept of relating a role and report to related events which are of interest to the current report;
The algorithm/logic used in dynamically tracking and rendering the above, and,
The concept of relating a role and report to a related source system from which the data is sourced, including the owners of these source systems;
The algorithm/logic used in dynamically tracking and rendering the above.

The concept of relating a role and report to an associated action item and rendering it dynamically shows all the action items which can be triggered at the time the information consumer is analyzing the data considers the following:
The algorithm/logic used in dynamically tracking and rendering the above;
The concept of relating a role and report to a percentage rejection which occurred while loading the repository;
The algorithm/logic used in dynamically tracking and rendering the above.
The concept of relating a role and report to the date of last refresh and the date of next refresh; and,
The algorithm/logic used in dynamically tracking and rendering the above.

In the metamodel which is used to dynamically capture the relationships, a flow chart/algorithm is used.

In a second embodiment, the invention resides in method of producing and displaying a required analytical report for displaying data including and based on specific contextual information which is specific to the required analytical report by using available general contextual information, comprising the steps of: selecting report-attributes of report ID/what-if ID, subscriber ID and report role ID which are characteristic of the required analytical report; a user selecting a rule set which is geared to obtaining specific properties of interest to the user in the report, inputting said report attributes and the rule-set individually into a user interface and gaining access into the general available contextual information including related reports, events/alerts, action items and contextual metadata; using the inputted report attributes, narrowing down selections from available said general contextual information to arrive at said specific contextual information relevant to the required analytical report; and, selectively displaying the data and the specific contextual information to the user as prompted. The rule set may be so chosen by the user that when a specific report display is initiated, the various updated comments by different consumers related to the specific report are also displayed. It is conceivable that the contextual information is available in a database or a cluster of databases which are continually updated as to the information which is accessed by the user each time a report is initiated. Instead of a database or a cluster of databases, the information may be taken or accessed from a cluster of files or any of the available file systems.

The invention also resides in an article comprising a storage medium having instructions thereon which when executed by a computing platform result in execution of a method for producing and displaying a required analytical report for displaying data including and based on specific contextual information which is specific to the required analytical report by using available general contextual information, comprising the steps of the methods recited above.

### BRIEF DESCRIPTION OF THE DRAWING

A more detailed understanding of the invention may be had from the following description of embodiments, given by way of example. In the following detailed description of the embodiments, reference is made to the accompanying drawing that forms a part hereof, and in which are shown by way of illustration of specific embodiments in which the invention may be practiced. It is understood that other embodiments may be utilized and changes in configuration may be made without departing from the scope of the present invention. In the accompanying drawing:

FIG. 1 (comprising sheets 1A, 1B and 1C) illustrates a flow diagram of an exemplary embodiment of the invention wherein the report attributes of the report required by the user comprise role ID, subscriber ID and report ID/what-if ID;

FIGS. 2A-2F illustrate a metamodel diagram used in implementing an embodiment of the present invention;

FIG. 3 illustrates a general purpose computing platform that can be used in implementing the invention; and,

FIG. 4 illustrates a sample screenshot of a rendered screen for viewing by a user.

### DETAILED DESCRIPTION

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims, and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

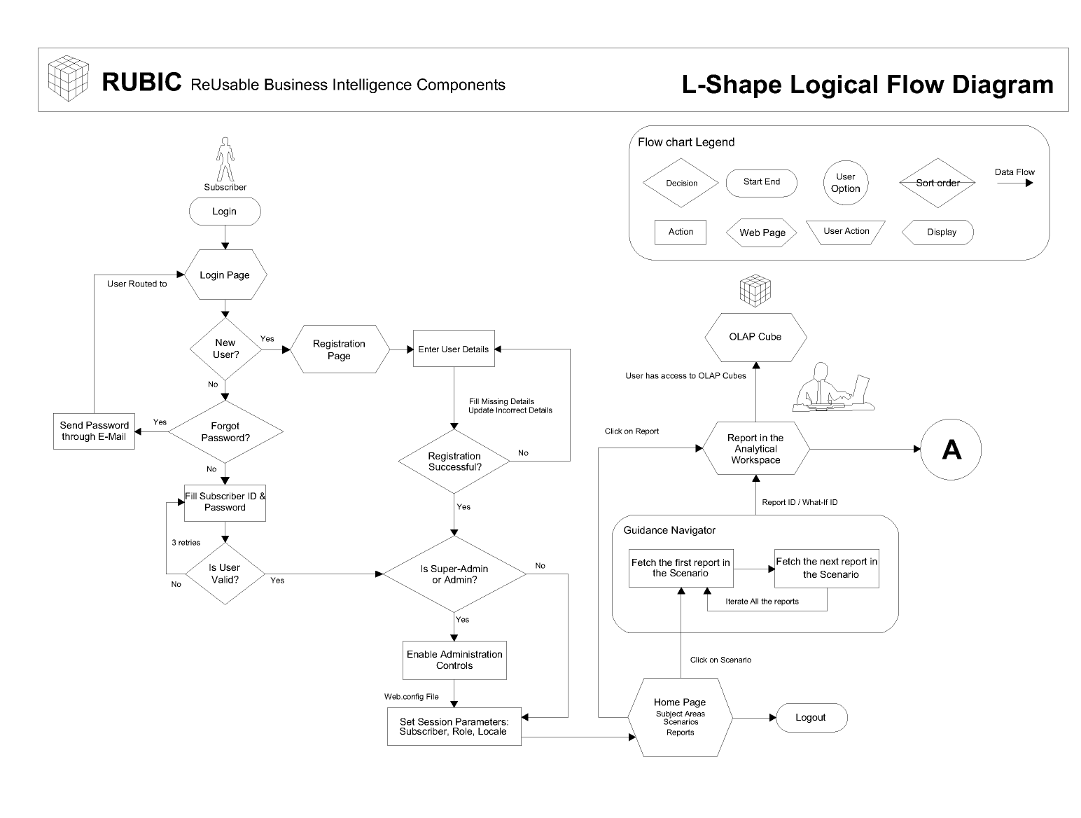

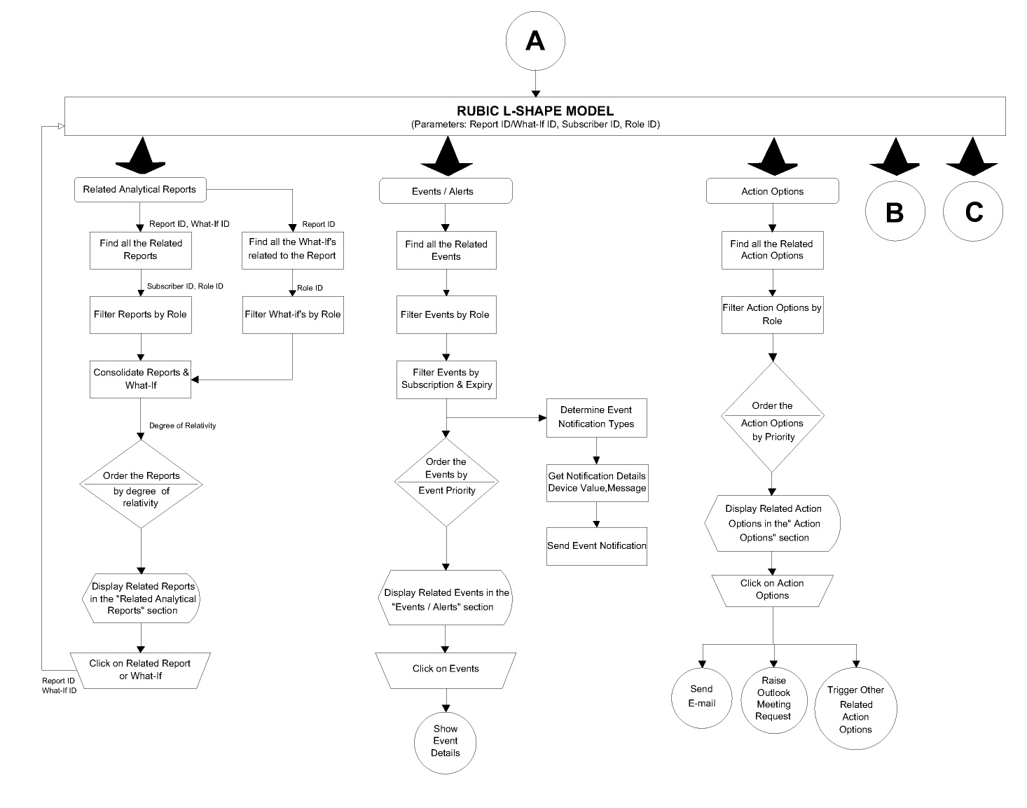

With specific reference to FIG. 1, a flow diagram with the report-attributes of role ID, subscriber ID, and report ID/what-if ID and a process of screening/narrowing available contextual information to obtain the report-specific information for display is illustrated. As shown for example, the available contextual information is accessed in at least four different categories accessed in four different columns including related reports, events/alerts, action options/items and contextual metadata, for purposes of screening or narrowing down the information to obtain specific information pertaining to the required report which the user wishes to create/display. The number of different categories accessed may a number other than four, and the different categories accessed may be different from the ones shown in the FIG. 1 illustration. The process of narrowing down or filtering the available contextual information in each panel in the context map might for example comprise inputting the report ID/what-if ID and the role ID in any desired sequence to obtain a screened output wherein there are five or more items of applicable information.

The flowchart in FIG. 1 for example, during the process of filtering or narrowing down the applicable contextual information choices, illustrates a method of handling data by the degree of relativity, e.g., five or more applicable items, to arrive at a contextual metadata item that is required and will be used for formulating the required report. Also shown in the first column of FIG. 1 is a flow-loop that addresses what-if scenarios, as applicable. Likewise, in the second column of FIG. 1 which is dedicated to events/alerts, the flow chart not only shows the process of narrowing down or filtering the contextual information, but also shows a secondary path leading to event notification types, which can be obtained and delivered out of the system. The third column in FIG. 1 is directed to action options/items, which are accessed as in columns 1 and 2, and narrowed down or filtered to obtain specific contextual information of action items which will be applicable to a required report which the user intends to generate and display. At the end of the filtering process in column three, there is indicated a prompt which shows that the action items may be mailed to the intended recipients, or, meeting requests may be sent to the intended recipients, or other related action options may be triggered, as applicable. The inclusion of the action options/items shown in column three is only by way of example, and the third column could be modified to include any other desired variable or characteristic. As shown in FIG. 1, the fourth column is dedicated to contextual metadata which is gain screened from available contextual form to a specific form by using the available contextual as a filtering criterion. The fourth column could be dedicated to any other characteristic other than contextual metadata, as desired by the user, and, the illustration in FIG. 1 is only an example. As shown, the metadata related to the required report includes information pertaining to the data sources, data owner, refresh interval, reject %, and time lapsed since the last refresh.

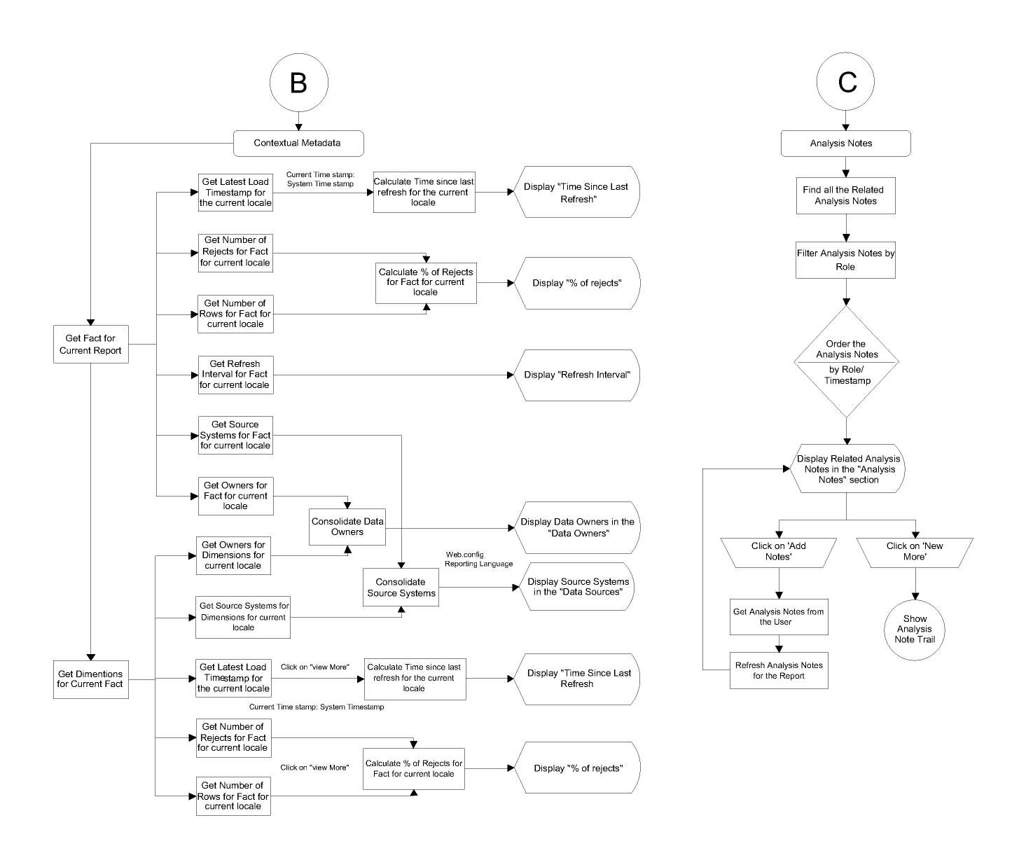

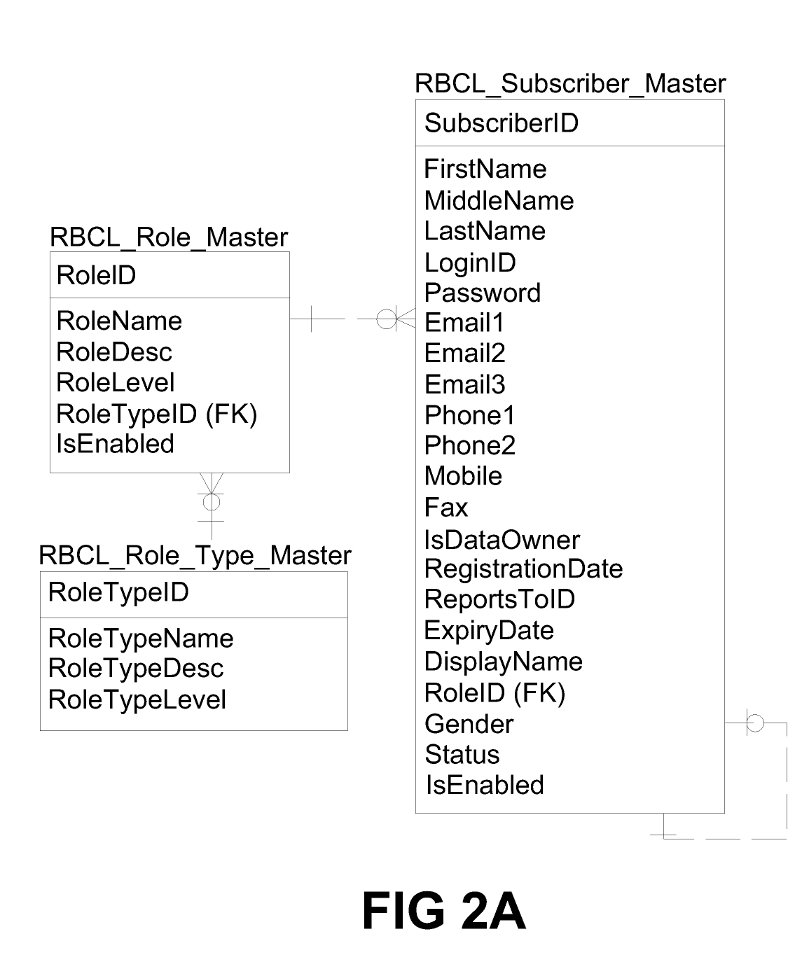

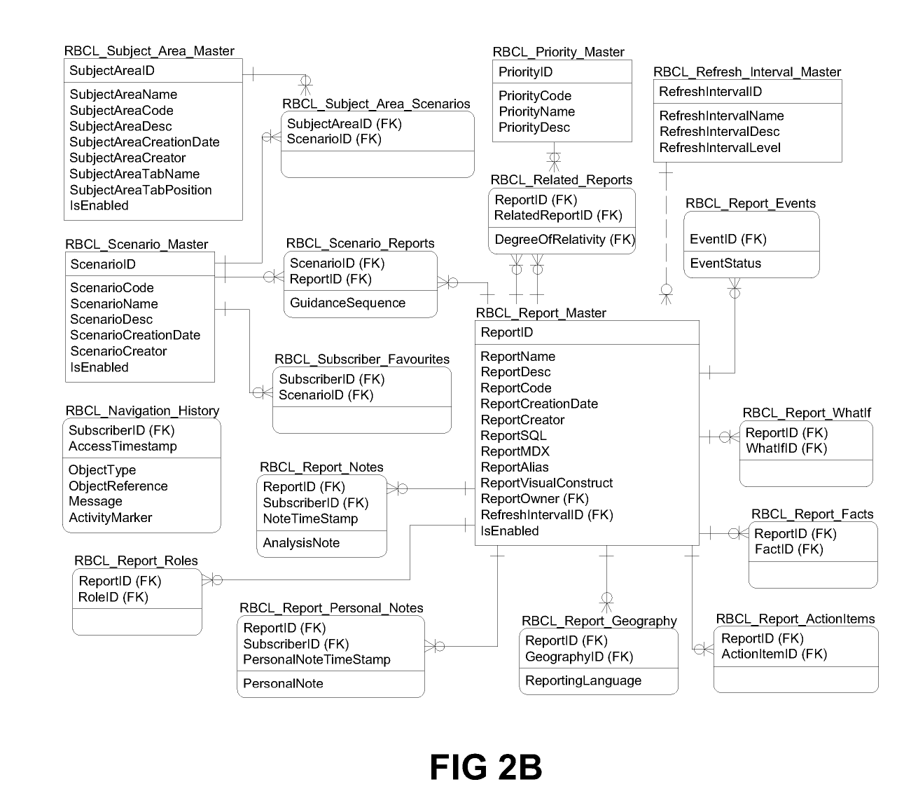

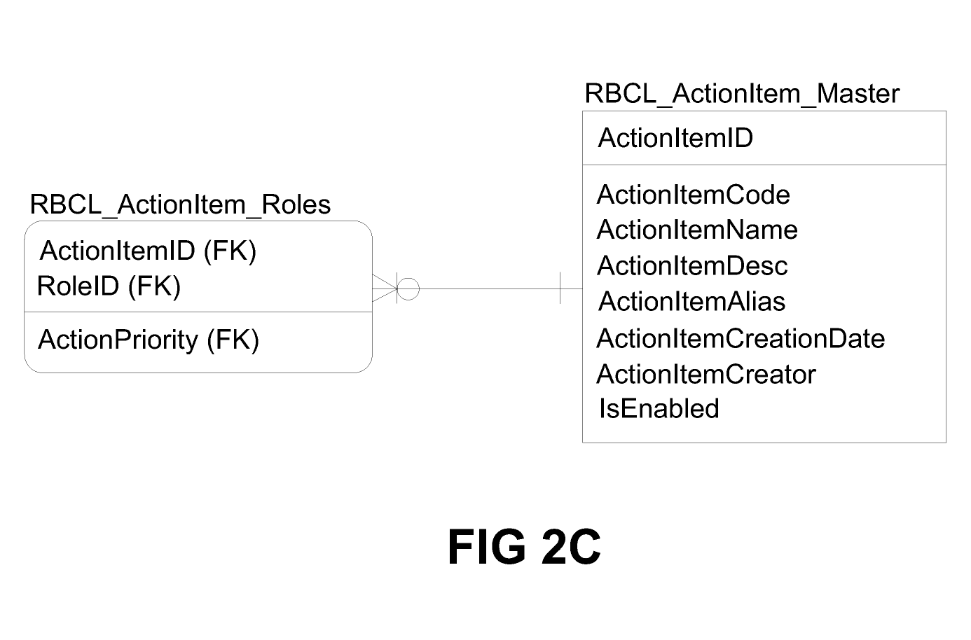

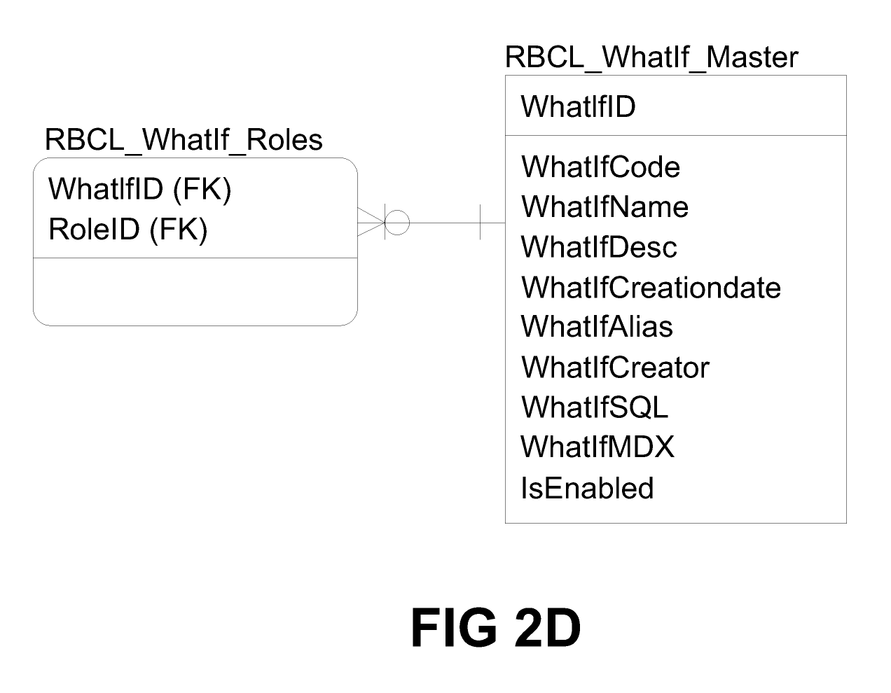

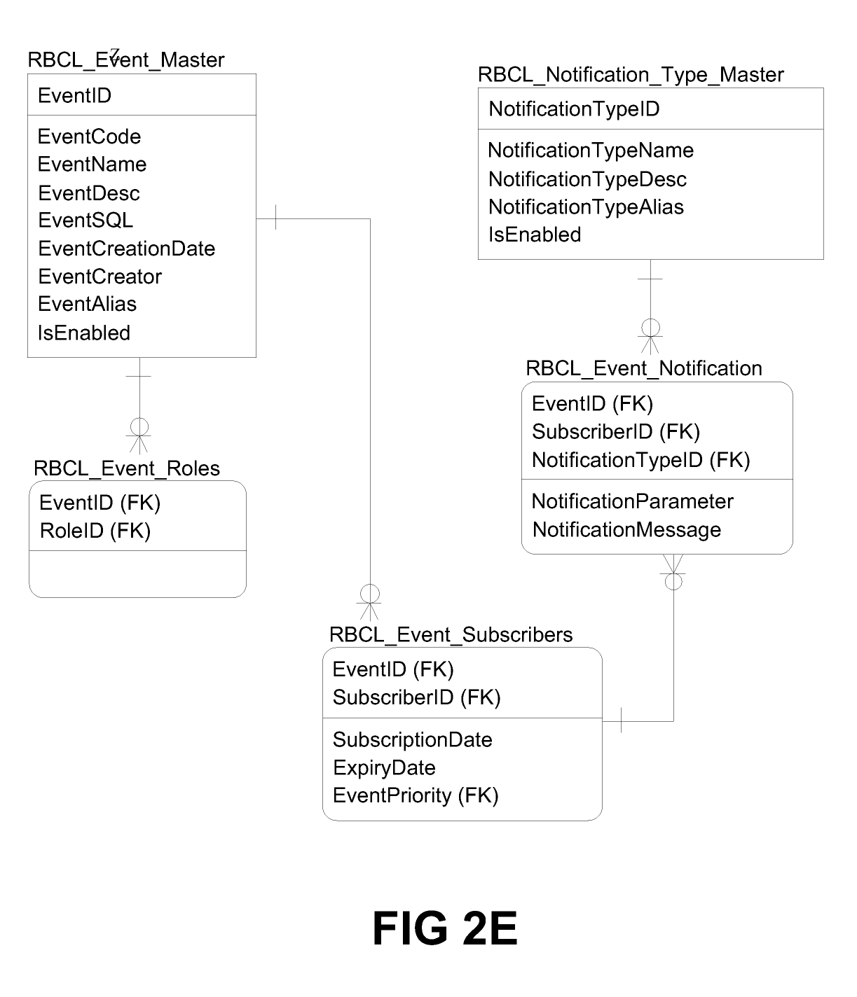

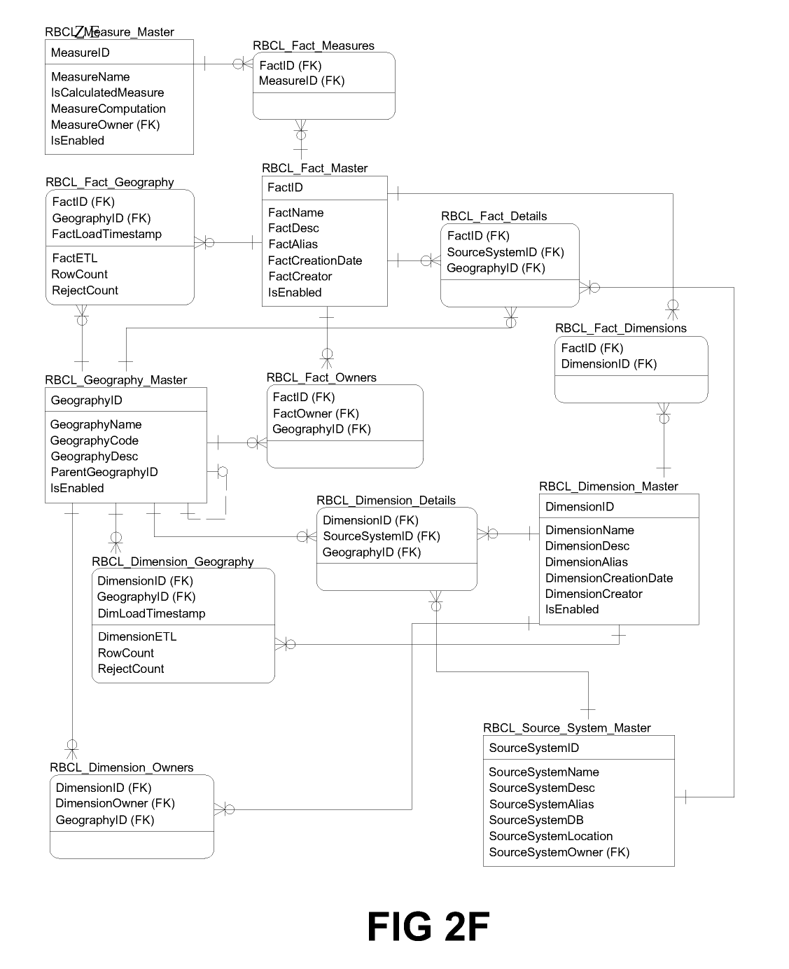

FIGS. 2A to 2F illustrate an exemplary metamodel, showing (incorporating ReUsable Business Intelligence Components) an L shape model which parallels the illustration of the flow chart in FIG. 1, but includes some specific additional details as purely an example. The following descriptive information relating to FIGS. 2A to 2F captures the metamodel details of data applicable when a user logs into the system to generate/view a specific required report.

One embodiment of the invention simultaneously brings together the following metadata elements of a report:
Related what-if scenarios which can be activated within the context of this report:

For example, if the end information consumer notices that there is a spike which happens in sales for a given time frame based on past data, he may then be guided to the related reports panel and look at the stock out situations for that region based on the warehouse holdings through the related scenarios panel of the contextual metadata mapper.
Related events which are of interest to the current report:

For example, the end information consumer tracking sales figures may notice through the events metadata panel that the sales numbers missed the targets 3 times in the last 7 months. He may notice that the contribution of certain products to the overall sales is declining (inflecting downwards) through the events panel of the contextual metadata mapper.
Related source systems from which the data is sources, the owners of these source system:

For example, the sales information could have come from a point of sales information, and the targets for the region could have come from a planning system and the stocks at depots from a 3^{rd} party system.
It shows all the action items which can be triggered at the time the information consumer is analyzing the data.

For example, if the person consuming sales information notices a dip in the sales figures continuously for last 3 months he may decide to trigger one of the following actions:

A) Introduce a temporary price reduction for the item which is slow moving.

B) Introduce a gift scheme along with the item which is slow moving.

C) Call for a meeting of regional sales people to discuss the trend.
It shows the percentage rejection which occurred while loading the repository

For example, if a lot of point of sales transactions got rejected at the business rule check layer, then the sales figures could look much skewed.
It shows the date of last refresh and the date of next refresh.

For example, if the sales data was refreshed at the beginning of the month then the sales which happened as a result of last week's promotion may not get reflected here.
Related reports which can be seen in the context of this report:

For example, if the end information consumer notices that there is a discrepancy in the sales numbers he may look at the source metadata for further information. This panel could attribute the discrepancy to one or more of the following:
The information is not coming from a trusted source (visible from source system tag) since, while loading the data repository a majority of the sales data got rejected due to business rule violations (visible from the percentage rejects tag). This is rendered through the operational metadata panel of the contextual metadata mapper.
It shows the comments/perspectives of other information consumers.

For example, if the end information consumer notices that there is a dip in the sales numbers he may get visibility into the comments panel which would give him a perspective of how other information-consumers of this report, interpreted the discrepancy in sales numbers. It could be due to a competitive promotional event, or it could be due to an attribute not valued by the customers. In any case, a subjective comment is entered into the comments panel, which is visible for multiple information consumers.

User Management:

With specific reference to FIG. 2A, the user accesses the system whereby the following data sets are captured:
1) List of all the roles & role types in the organization
2) List of all the subscribers and their details

All the details of the subscriber of the application like the First Name, Last Name, Email IDs, Phone numbers etc., are captured in the RBCL_Subscriber_Master table.

Every subscriber has a Username/LoginID and a Password using which he/she logs into the system.

Every subscriber has a definite role (RBCL_Role_Master) which is used to enforce access control to Reports and Configuration elements. These roles have a one-to-one association with the roles currently operating in the organization, for which this application is implemented.

In addition to roles, role types (RBCL Role_Type Master) are also defined, to enforce a second-tier security. The possible role-types are,
Super-Administrator: Full privileges.
Administrator: All privileges except that he/she cannot edit/delete the contextual metadata information.
Normal: A normal user. Cannot edit/delete any of the master table data.

A role belongs to one and only one role type.

The ‘RoleLevel’ is a numerical indicator which indicates the hierarchy of the role in the organization. The highest role is assigned a smaller value and lower roles are assigned higher values subsequently. No two roles can have the same level. For example, if there are three roles—A, B. C. And A is the highest, followed by B and then followed by C, the role levels would be as follows:

A—10 or 1 or . . .
B—20 or 2 or . . .
C—30 or 3 or . . .

The standard is to use multiples of 10 so as to accommodate any future changes/additions to the roles.

Similarly, the ‘RoleTypeLevel’ indicates the hierarchy of the role type.

The ‘IsEnabled’ Flag is used to enable/disable roles & subscribers. For subscribers, this flag could be used for temporary suspension.

The ‘ReportsToID’ indicates the Subscribers Super ordinate/Superior/Boss/Manager. This can be NULL if the subscriber has no super ordinate/superior/boss/manager. This information would be used in workflows, for approvals, for escalations etc.

In case the subscriber has lost/forgotten the password, the subscriber's date of birth may be used to verify the authenticity of the subscriber and a new password would be e-mailed to the primary email id of the subscriber.

For Event Notifications, the Primary Email (Email1) and the Mobile number would be used.

As soon as the subscriber fills in all his/her details, a registration request is sent to the Administrator/Super Administrator for his/her approval. The ‘Status’ field indicates the Status of the subscription.
APPROVED: The subscriber's details have been verified and he/she has been approved to use the system.
PENDING: The subscriber's registration is still pending. Details have not yet been verified.
REJECTED: The details have been verified and the request has been rejected. The subscriber would therefore not be able to use the system.

Only after the Administrator/Super Administrator has approved the registration, the user will be able to access the system.

‘ExpiryDate’ field indicates the expiry date of the subscription. NULL in this field would mean “AGELESS SUBSCRIPTION”

‘IsDataOwner’ flag indicates whether the subscriber is a Data Owner or not. A Data owner is the one who owns the source system data like Customer Master, Sales Data, and Stock Data etc. The Subscriber is not a Data owner by default.

‘Gender’: The allowed values are M—Male, F—Female

Reports:

The following data sets are captured:
1) List of all the implementation subject areas (Sales & Marketing, Finance etc).
2) List of all the Analysis Scenarios.
3) The Scenarios belonging to a Subject Area.
4) List of all the Reports.
5) List of all the What-Ifs.
6) Reports belonging to a Scenario.
7) Subscriber's favorite scenarios.
8) List of the priorities available.
9) Reports and the corresponding roles authorized to access them.
10) What-Ifs and the corresponding roles authorized to access them.
11) Related Reports & their degree of relativity.
12) What-Ifs applicable for a particular report.
13) Events applicable for a particular report.
14) Action Items applicable for a particular report.
15) Facts used in a report.
16) Geographies in which this report will be made available.
17) Navigation History.
18) Analysis notes for reports from a subscriber on a given date.
19) Personal notes for reports from a subscriber on a given date.
20) Refresh interval levels.

The following description is applicable to FIG. 2B:

Subject areas of the project are broad areas under which the analysis will be done. This is project-specific. For a FMCG implementation, for example, the subject areas could be Manufacturing, Sales & Marketing, Finance, Human Resource etc.

An Analysis Scenario is a sub-analysis performed under the subject area. For a FMCG implementation, for example, the scenarios could be, Promotion Effectiveness, Sales Trend analysis, etc., under the Sales & Marketing Subject Area.

A Scenario can belong to multiple Subject Areas while a Subject Area can have multiple Scenarios.

The reports are grouped under scenarios. A Report can belong to multiple Scenarios while a Scenario can have multiple reports.

The described Metamodel also captures the subscriber's 5 favorite analysis scenarios. These favorites would be available to the subscriber on the home page after successful login.

Priorities are attached to Reports, Event/Alerts, Action Items, What-Ifs etc. The available priority levels are:

1) Very High.

2) High.

3) Medium.

4) Normal.

5) Below Normal.

A report may have multiple roles accessing it. All the users who belong to that role would then be able to access the report. Also, a role may have access to multiple reports. Similarly, a What-If may have multiple roles accessing it. Also, a role may have access to multiple What-Ifs.

For a report, all of its related reports would be ordered by the degree of relativity. A report may have more than one related reports. A What-If can figure in multiple reports while a report can have multiple What-Ifs.

The L-shape Context panel populates the Related Reports Section for a Report by fetching the Reports & the What-Ifs relevant to a report and the role of the current subscriber.

| Report | Related Report | DegreeOfRelativity |
|---|---|---|
| R1 | R2 | 10 |
| R2 | R1 | 10 |

NOTE:
If Report 1(R1) and Report 2(R2) are related to each other, then there will be 2 entries in this table as shown below.

Events can figure in multiple reports while a report can have multiple Events.

‘Event Status’: The Status of the Event.

Yes: The event has occurred

No: The event has not occurred

Only the events which have the EventStatus as ‘Yes’ would be displayed in the L-shape Context Panel Events/Alerts section.

An Action Item can figure in multiple reports while a report can have multiple action items.

A report generally uses a single fact.

A report is currently configured only for a single Geography. A single Geography can have many reports.

All user-activity on the website is also captured in the form of Navigation History. ObjectType refers to the type of item/link accessed on the web page. ObjectType could be:

1) A Scenario.

2) A Report.

3) Action Item.

4) What-If.

5) Event.

6) Contextual Metadata.

7) Analysis Notes.

8) Configuration.

9) Cube.

10) Help.

ObjectReference is the actual name of the object which was accessed. For example, if the ObjectType is Scenario, then ObjectReference would contain the name of the Scenario, for example, Promotion Effectiveness Analysis.

ActivityMarker: These markers would then be used to calculate the average dwell time on a page per login. The markers are “START” to identify Login, “END” to identify logout.

Analysis Notes and Personal Notes are used by the subscriber to capture his/her comments/observations of the report. The analysis notes would be visible to all the users of the reports. The personal notes would be visible only to the user who created the note. This feature can be used by the user to make notes not for sharing but for future reference.

Refresh Interval indicates as to when this report will be refreshed next with fresh data. Refresh Intervals are project & report specific. Some of the values are: Instantaneous, Hourly, Daily, Weekly, Fortnightly, Monthly, Quarterly, Half-Yearly, Yearly, or Customized, to reflect 20 days, 25 days, etc.

With specific reference to FIG. 2C, the following data sets are captured:
1) List of all the Action Items
2) Action Items and the corresponding roles authorized to access them

An Action Item is typically available to multiple roles. A role can have multiple action items. So, whenever a subscriber logs in, his role will be checked to determine the action items accessible to his/her role.

The L-shape Context panel populates the Action Items for a Report by fetching the Action Items relevant to a report and the role of the current subscriber.

‘ActionPriority’: This indicates the priority of the action item to the role in question. The priorities of an action item may change with a change in roles. For example, a salesman would like to ‘Email’ his boss when he sees an inflection in the sales report. But a Vice President of Sales would like to ‘Call for a meeting’ on seeing the same inflection. Thus, the action items should be ordered by priority for different roles.

What-If: With specific reference to FIG. 2D, the following data sets are captured:
1) List of all the What-Ifs
2) What-Ifs & the corresponding roles authorized to access them

A What-If may have multiple roles accessing it. And a role can access multiple What-Ifs. All the users who belong to a role would be able to access the what-If accessible to that role.

The L-shape Context panel populates the Related Reports Section for a Report by fetching the What-Ifs relevant to a report and the role of the current subscriber.

Events/Alerts:

With specific reference to FIG. 2E, the following data sets are captured:
1) List of all the events/alerts.
2) Events/Alerts & the corresponding roles authorized to access them.
3) Event Subscription details as to which user has subscribed to what events.
4) Event Notification preferences for a user.

An Event/Alert may be accessed by multiple roles. And a role can have multiple event/alert subscriptions. All the users who belong to a role would then be able to access the Event/Alert accessible to that role.

The L-shape Context panel populates the Events/Alerts for a Report by fetching the Events/Alerts relevant to a report, role of the current subscriber, and the current subscriber's event subscription status (RBCL_Event_Subscribers) in order. Only the subscriber of the event can view the event in the L-Shape Context Panel Event/Alerts section.

The described Metamodel also captures the subscriber's event notification preference (RBCL_Event_Notification) for every event to which he/she has subscribed. For example, Subscriber A would want to be notified through Email for Event X but through SMS for Event Y. A subscriber could be notified through multiple channels for the same event.

The possible notification type values are:

Mobile Telephone: Sent as an SMS.

Email: Sent via Email.

Display: Displayed in the L-Shape Context Panel “Events/Alerts” section.

By default, “Display” is enabled for all users.

Contextual Metadata:

With specific reference to FIG. 2F, the following data sets are captured:
1) List of all the Data Warehouse Dimensions & their owners.
2) List of all the Data Warehouse Facts & their owners.
3) List of all the Geographies that the organization operates in
4) List of all the Source systems.
5) Dimension and its Geography-wise data sourcing details.
6) Fact and its Geography-wise data sourcing details.
7) ETL (Extracting, Transforming, Loading) which populates the given dimension/fact for a particular geography, the time when this dimension/fact was loaded.
8) Dimensions belonging to the Fact tables.
9) The measures belonging to a particular fact.

The dimension & a fact could be sourced from multiple source systems, and a source system can contain data of multiple facts and dimensions.

A fact table can use multiple dimensions and a dimension can be used by multiple fact tables. A measure generally belongs to a single fact. A fact table can contain more than one measure.

A dimension or a fact may have multiple owners for a particular geography. A subscriber can be an owner of multiple dimensions or facts in multiple geographies.

When displaying the contextual metadata for a report, the latest load time is being considered for the current geography of the user. In this way, the history information is also available for future reference. The table contents may be purged to a file/table/Data Warehouse at regular intervals.

‘RowCount’: Total number of rows loaded into the dimension by the ETL.

‘RejectCount’: Total number of rows rejected during this ETL load. The Reject percentage would be calculated as, Rejected %=(RejectCount/RowCount)*100.

The following are some of the advantages of the described embodiments which incorporate the features described:
A common contextual metadata related to the framework of operational metadata, events metadata, and comments metadata, is attached to the specific invoked report.
The contents of the contextual metadata are dynamic and change with every report which is “touched” or “invoked”.
The metadata model which keeps track of the relationship between a report/analytical construct and the associated contextual metadata is unique and flexible.
The design of the application layer which invokes the dynamic content based on the report/analytical construct is unique.
The visual interface which takes the form of the “L” shaped panel with the actual analytical construct/report in the top left corner, the supporting metadata in the panel.
This model can be used for financial compliance reporting like Sarbanes Oxley compliance reports and BASEL compliance reports which need to be submitted to an external regulator, and, the context surrounding the reports presented is as useful as the actual data.
The contextual metadata contains related analytical areas which may be of interest to the current user, based on the current analysis.
The contextual metadata contains a panel which lists the what-if scenarios possible within the context of the current report.
The contextual metadata contains a panel which lists the operational metadata linked to the reports-data source, % of rejects, and data owners which are explicitly tied to each report in an analytical application framework.

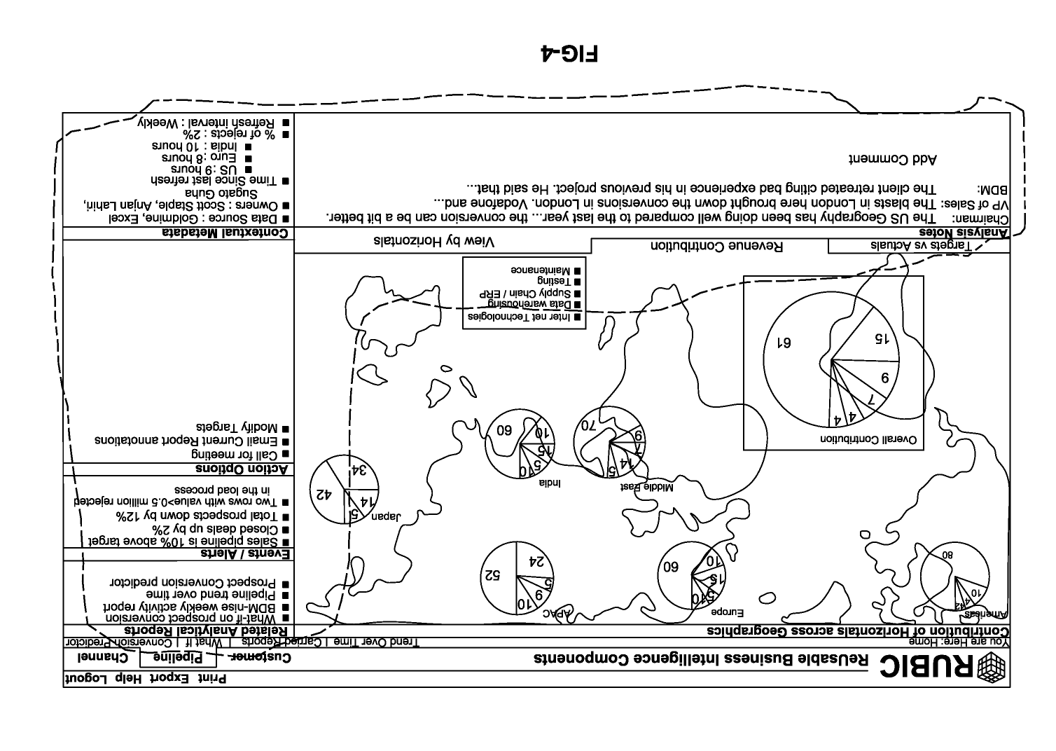

FIG. 4 illustrates a sample screenshot of a rendered screen which is generated from user inputs and choices and may be viewed by the user. The salient features of the screenshot of FIG. 4 include:

a) The contextual metadata for the generated report is available without any additional mouse clicks.

b) The top left panel highlights the reports which can be consumed in the context of the report.

c) The second panel from the right side corner displays the events related to the current report.

d) The third panel from the top right corner displays the possible action items along with the report.

e) The fourth panel from the top right corner displays operational data-feed-related information like source, owner, last refresh and next refresh dates, etc.

f) The panel below the report captures the notes associated with the report.

g) The notes can be private notes (visible only to the current user) and/or public notes (visible to others consuming the report).

h) The panel rendering is refreshed dynamically when the report invokes changes.

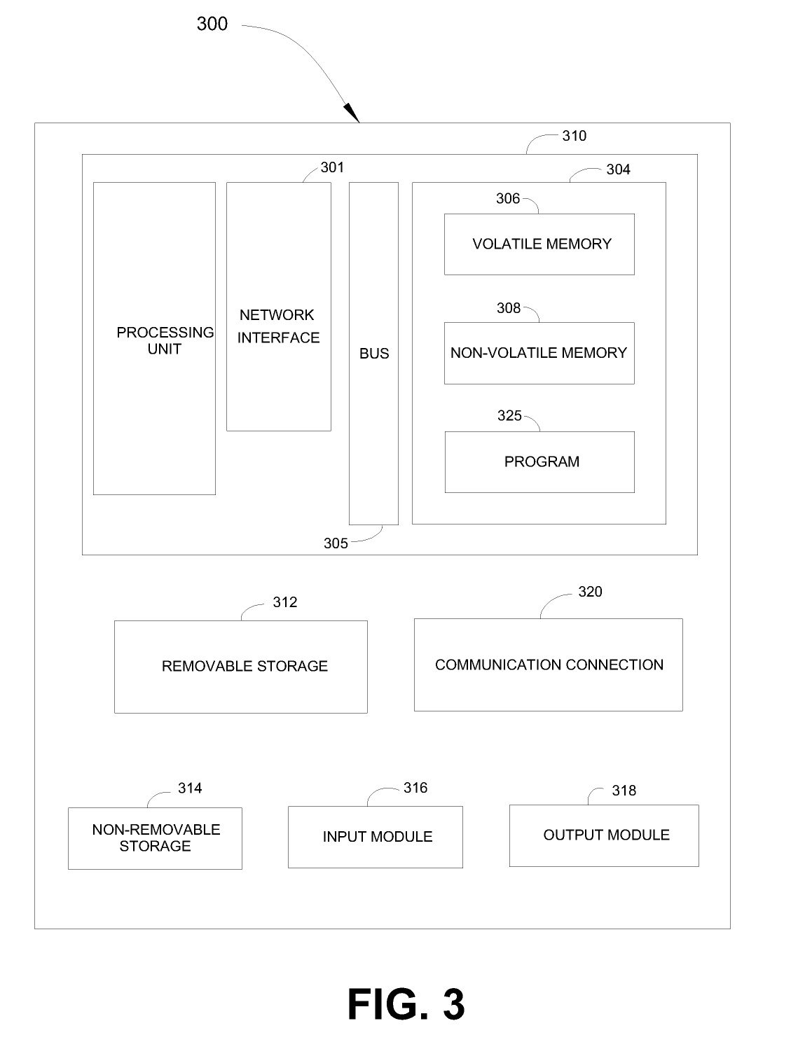

Various embodiments of the present subject matter can be implemented in software, which may be run in the environment shown in FIG. 3 or in any other suitable computing environment. The embodiments of the present subject matter are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. It is also noted that the embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, the program modules may be located in local or remote storage devices.

FIG. 3 shows an example of a suitable computing system environment for implementing embodiments of the present subject matter. FIG. 3 and the following discussion are intended to provide a brief, general description of a suitable computing environment in which certain embodiments of the inventive concepts contained herein may be implemented.

A general computing device in the form of a computer 310 may include a processing unit 302, memory 304, removable storage 312, and non-removable storage 314. Computer 310 additionally includes a bus 305 and a network interface (NI) 301. Computer 310 may include or have access to a computing environment that includes one or more user input devices 316, one or more output modules or devices 318, and one or more communication connections 320 such as a network interface card or a USB connection. One or more user input devices 316 can be a touch screen and a stylus or the like. The one or more output devices 318 can be a display device of computer, computer monitor, TV screen, plasma display, LCD display, display on a touch screen, display on an electronic tablet, or the like. The computer 310 may operate in a networked environment using the communication connection 320 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 304 may include volatile memory 306 and non-volatile memory 308. A variety of computer-readable media may be stored in and accessed from the memory elements of computer 310, such as volatile memory 306 and non-volatile memory 308, removable storage 312 and non-removable storage 314. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like, chemical storage, biological storage, and other types of data storage.

“Processor” or “processing unit” as used herein, means any type of computational circuit, such as, but not limited to a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 302 of the computer 310. For example, a computer program 325 may include machine-readable instructions capable of providing a specific displayable report including applicable metadata based on user-defined rule-set according to the teachings of the described embodiments of the present subject matter. In one embodiment, the computer program 325 may be included on a CD-ROM and loaded from the CD-ROM to a hard drive in non-volatile memory 308. The machine-readable instructions cause the computer 310 to decode according to the various embodiments of the present subject matter.

The foregoing is the description of exemplary implementations of the method and system for producing and displaying a report with a metamodel which captures all applicable relationships and dynamically serves the relationship to the next application. The above-described implementation is intended to be applicable, without limitation, to situations where specific report generation needs to be performed to track or watch parameters of the user's choice. The description hereinabove is intended to be illustrative, and not restrictive.

The various embodiments of the model described herein are applicable generally to any system/method for report generation including specific contextual information as driven by user defined report attributes and rule-set, and the embodiments described herein are in no way intended to limit the applicability of the invention. In addition, the techniques of the various exemplary embodiments are useful to the design of any implementations of software, firmware, and algorithms in the context of specific report generation with contextual information display in general. Many other embodiments will be apparent to those skilled in the art. The scope of this invention should therefore be determined by the appended claims as supported by the text, along with the full scope of equivalents to which such claims are entitled.

1. A method of producing and displaying a required analytical report for displaying data including and based on specific contextual information which is specific to the required analytical report selected from and by using available general contextual information, comprising the steps of:
a user selecting report-attributes which are characteristic of the required analytical report;
selecting a rule-set determined by the user for deriving events/specific information to be watched/displayed; and,
selectively inputting said report attributes and rule-set individually into a user interface and gaining access into the general available contextual information.

2. The method of claim 1, further comprising: using the inputted report attributes and the rule-set, filtering and narrowing down selections from available contextual information to arrive at said specific contextual information relevant to the required analytical report.

3. The method of claim 2, further comprising: selectively and simultaneously displaying to the user as prompted, the specific contextual information and data chosen from related what-if scenarios, related events, related source systems, related real time action items, related percentage rejection, related date of last refresh and date of next refresh, related other reports, and comments/perspectives of other information consumers.

4. A method of producing and displaying a required analytical report for displaying data including and based on specific contextual information which is specific to the required analytical report selected from and by using available general contextual information, comprising the steps of:
a user selecting report-attributes which are characteristic of the required analytical report;
selecting a rule-set determined by the user for deriving events/specific information to be watched/displayed;
selectively inputting said report attributes and rule-set individually into a user interface and gaining access into the general available contextual information;
using the inputted report attributes and the rule-set, filtering and narrowing down selections from available contextual information to arrive at said specific contextual information relevant to the required analytical report; and,
selectively displaying the data and the specific contextual information to the user as prompted.

5. The method as in claim 4, wherein the report attributes comprise report ID/what-if ID, subscriber ID and report role ID, and wherein said rule-set comprises events chosen by the user.

6. The method as in claim 5, including the steps of selectively associating a role from the role ID with a subscribed event or an inflexion point in a graph that is desired to be watched by the user.

7. The method as in claim 5, wherein said general available contextual information comprises related reports, events/alerts, action items and metadata, and wherein said rule set relates selectively to sales, finance, or other varying events of interest.

8. The method as in claim 5, wherein the step of narrowing down comprises narrowing down selections of:
a) applicable related reports from all available related reports by inputting report ID/what-if ID and role ID;
b) applicable events and alerts from all available event/alert information by inputting report ID/what-if ID, role IDE, and subscriber ID;
c) applicable action items from all available action items by inputting report ID/what-if ID and role ID; and,
d) applicable contextual metadata from all available contextual metadata by inputting report ID/what-if ID and role ID.

9. The method as in claim 8, wherein in the steps a), b), c), and d) for narrowing down selection, the inputting of report ID/what-if ID and role ID is done by first inputting report ID/what-if ID, and in a subsequent step by inputting role ID.

10. The method as in claim 9, wherein in the steps a), b), and c), in the event that a number of narrowed down applicable related reports, applicable events and alerts, and applicable action items appear individually to exceed a predetermined number, the method including the step of grid-paging and a subsequent step of ordering by priority.

11. The method as in claim 10, wherein the predetermined number is 7.

12. The method as in claim 9, wherein in the steps a), b), and c), in the event that a number of narrowed down applicable related reports, applicable events and alerts, and applicable action items appear individually not to exceed a predetermined number, the method including the step of making an item choice by applying a known priority.

13. The method as in claim 12, wherein the known priority for the step a) comprises a degree of relativity.

14. The method as in claim 13, wherein the step a) includes “what-if” considerations.

15. The method as in claim 14, including:
(i) a step of clicking on applicable related reports for step a),
(ii) initiating a show of applicable event details for step b),
(iii) initiating triggering applicable related action items such as sending mail and sending meeting requests, and.
(iv) displaying applicable metadata related to said required analytical report.

16. The method as in claim 15, wherein in step (iv), the applicable metadata selectively includes data sources, data owner, refresh/update interval, reject % and time elapsed since last update.

17. The method as in claim 8, wherein step a) includes a parallel step for processing all available related reports through narrowing/filtering steps using report ID/what-if ID and role ID in sequence for respectively finding “what-ifs” pertaining to the related report and filtering “what-ifs” by role.

18. The method as in claim 8, wherein step b) includes the narrowing down selection of applicable events/alerts by inputting report ID/what-if ID, role ID and subscriber ID in a sequence, the method further including, after a step of filtering of events by event subscription/expiry, a step of getting event notification types and selectively initiating sending event notification messages.

19. The method as in claim 8, wherein in step c), if the applicable event items exceed a predetermined number, said step of selecting is advanced to ordering by priority.

20. The method as in claim 19, wherein the predetermined number is 7.

21. The method as in claim 8, wherein applicable contextual metadata is selected by inputting report ID/what-if ID as an identifier.

22. The method as in claim 21, wherein the selected applicable contextual data comprises metadata related to data sources, data owner, refresh/update interval, reject %, and time lapsed since a last refresh update.

23. The method as in claim 4, wherein the step of displaying comprises displaying the required analytical report and specific contextual information in an L shaped format.

24. An article comprising a storage medium having instructions thereon which when executed by a computing platform result in execution of a method for producing and displaying a required analytical report for displaying data including and based on specific contextual information which is specific to the required analytical report by using available general available contextual information, comprising the steps of claim 4.

25. A method of producing and displaying a required analytical report for displaying data including and based on specific contextual information which is specific to the required analytical report by using available general available contextual information, comprising the steps of:
selecting report-attributes of report ID/what-if ID, subscriber ID and report role ID which are characteristic of the required analytical report;
formulating a user-defined rule-set for obtaining specific metadata in the analytical report;
inputting said report attributes and said rule-set individually into a user interface and gaining access into the general available contextual information including related reports, events/alerts, action items and contextual metadata;
using the inputted report attributes, narrowing down selections from available said general available contextual information to arrive at said specific contextual information relevant to the required analytical report; and,
selectively displaying the data and the specific contextual information to the user as prompted.

26. An article comprising a storage medium having instructions thereon which when executed by a computing platform result in execution of a method for producing and displaying a required analytical report for displaying data including and based on specific contextual information which is specific to the required analytical report by using available general available contextual information, comprising the steps of claim 25.
